(19) United States
(12) Patent Application Publication
(10) Pub. No.: US 2025/0107958 A1
(43) Pub. Date: Apr. 3, 2025

(54) A PORTABLE APPARATUS TO DELIVER PERCUSSION AND VIBRATIONS TO A PULMONARY REGION OF A PATIENT

(71) Applicant: Ji Min CHOW, Pulau Pinang (MY)

(72) Inventor: Ji Min CHOW, Pulau Pinang (MY)

(21) Appl. No.: 18/845,392

(22) PCT Filed: Mar. 9, 2023
(86) PCT No.: PCT/MY2023/050015

§ 371 Date: Sep. 9, 2024

(30) Foreign Application Priority Data
Mar. 9, 2022 (MY) PI2022001328

(51) Int. Cl. A61H 23/00; A61H 23/02

(52) U.S. Cl. CPC A61H 23/006; A61H 23/0254; A61H 2201/0153; A61H 2201/0157; A61H 2201/0165; A61H 2201/1215; A61H 2201/1621; A61H 2201/1626; A61H 2201/1635; A61H 2201/165; A61H 2201/1657; A61H 2201/169; A61H 2205/084

(57) ABSTRACT

A portable apparatus to deliver percussion and vibrations to a pulmonary region of a patient is disclosed. The apparatus comprises a support means (110) and at least one percussion device (100). The support means (110) includes at least one portion to receive and hold the percussion device (100). The percussion device (100) includes a casing (102) having at least one actuator (104, 106) operatively coupled to power at least one contact head (108) for delivering percussion and vibrations to the patient. The contact head (108) is operable to compress the chest to a depth in the range of 1 mm to 10 mm at a frequency within the range of 1.0 Hz to 16.67 Hz and with a force within the range of 0.05 to 3 kilogram-force (kgf) or 0.4903325-29.41995 newton (N). The portable apparatus is configurable as a wearable or handheld apparatus.

### FIELD OF THE INVENTION

The present invention relates to a portable apparatus. Particularly, to a portable apparatus having a therapeutic device for effecting percussion and vibrations to a pulmonary region of a patient.

### BACKGROUND OF THE INVENTION

Chronic obstructive pulmonary disease (COPD) is a chronic inflammatory lung disease that causes obstructed airflow from the lungs. COPD also increases the risk of developing heart diseases, lung cancer and a variety of other conditions. Typically, COPD can be treated by using inhaled medication and airway clearance devices. Conventionally, many airway clearance devices have been proposed to clear accumulation of mucus and sputum in the lungs of patients. These airway clearance devices include a flutter mucus clearance, Intrapulmonary Percussive Ventilation (IPV) device, Oral High-Frequency Oscillation (OHFO) device, High-Frequency Chest Wall Oscillation (HFCWO) device and Lung Flute Acoustic Induction device to name a few.

The flutter mucus clearance device is typically used along with positive expiratory pressure (PEP) therapy. In PEP, a patient uses a face mask or a mouthpiece while inhaling and exhaling. The face mask or mouthpiece provides mild air pressure as you exhale to gently dislodge excess sputum and push it toward the larger airways, making it easier to cough up. The flutter mucus clearance device combines PEP with high-frequency oscillation that create vibrations once a patient exhales, to loosen mucus from bronchial walls while accelerating airflow to better stimulate mucus clearance.

An IPV device delivers small bursts of air into a patient's lungs through a mouthpiece. The pulsatile bursts of air delivered with an IPV device serve to vibrate the chest, which loosens mucus deep in the airways. An OHFO device delivers low volume, high-frequency jet oscillation to the patient's lungs through a mouthpiece. The oscillation is produced using sound frequency. A HFCWO device is comprised of an inflatable vest which uses air pressure to gently vibrate the chest wall and thus increases airflow to the smaller passages and aids in the clearance of mucus. The lung flute is a hand-held device that generates low-frequency sound waves into the airways to stimulate mucus clearance.

The conventional airway clearance devices work on the principle of introducing vibrations into the chest or a patient's airway. However, these devices are directly engaged in the mouth or on the pulmonary region of the patient. The direct engagement makes the oscillations or high frequency vibrations directly compress the patient's chest at a rapid pace or high force causing discomfort and pain.

There is therefore a need for an airway clearance device that introduces percussion and vibrations to a patient without causing any pain or discomfort to the patients during therapy while maintaining the efficacy of the treatment.

### SUMMARY OF THE INVENTION

The present invention discloses a portable apparatus to deliver percussion and vibrations to a pulmonary region of a patient. The apparatus comprises a support means and at least one percussion device.

Typically, the support means includes at least one portion to receive and hold the percussion device.

Preferably, the percussion device includes a casing having at least one actuator operatively coupled to power at least one contact head for delivering percussion and vibrations to the patient. The contact head is operable to compress the chest to a depth in the range of 1 to 10 millimeters (mm) at a frequency within the range of 1.0 to 16.67 hertz (Hz) and with a force within the range of 0.05 to 3 kilogram-force (kgf) or 0.4903325-29.41995 newton (N).

Preferably, the apparatus is wearable by the patient, wherein the support means is configured as a garment means extending at least partially around the chest of the patient, such that the percussion device is in contact with the chest region of the patient during therapy. More preferably, the garment means is selected form a group consisting of: a vest, jacket, brace and chest band.

Alternatively, the garment means is wearable by a medical professional attending the patient, wherein the garment means is configured as a band worn around a wrist and/or palm of the medical professional and the apparatus is held against the patient's chest or back during the therapy. Furthermore, the apparatus can be handheld by the medical professional, wherein the support means is configured as one or more handles attached to the percussion device, such that the medical professional grasps the handles to hold the percussion device against the patient's chest or back during the therapy.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE ACCOMPANYING DRAWINGS

The present invention will be fully understood from the detailed description given herein below and the accompanying drawings which are given by way of illustration only, and thus are not limitative of the present invention, wherein:

FIG. 1 is cross sectional view of the percussion device worn around the chest of the patient, in accordance with a first embodiment of the present invention.

FIG. 2 is cross sectional view of the percussion device while compressing the chest of the patient.

FIG. 3 shows a cross sectional view of the percussion device worn over hand of a medical professional and held against the chest of the patient, in accordance with a second embodiment of the present invention.

### DETAILED DESCRIPTION

In accordance with the present invention, there is provided a portable apparatus to deliver percussion and vibrations to a pulmonary region of a patient which will now be described with reference to the embodiment shown in the accompanying drawings. The embodiment does not limit the scope and ambit of the invention. The description and phraseology or terminology employed herein is for the purpose of description and not of limitation.

The embodiment herein and the various features and advantageous details thereof are explained with reference to the non-limiting embodiment in the following description. Descriptions of well-known components and processing techniques are omitted to not unnecessarily obscure the embodiments herein. The examples used herein are intended merely to facilitate an understanding of ways in which the embodiment herein may be practiced and to further enable those of skill in the art to practice the embodiment herein. Accordingly, the description should not be construed as limiting the scope of the invention herein.

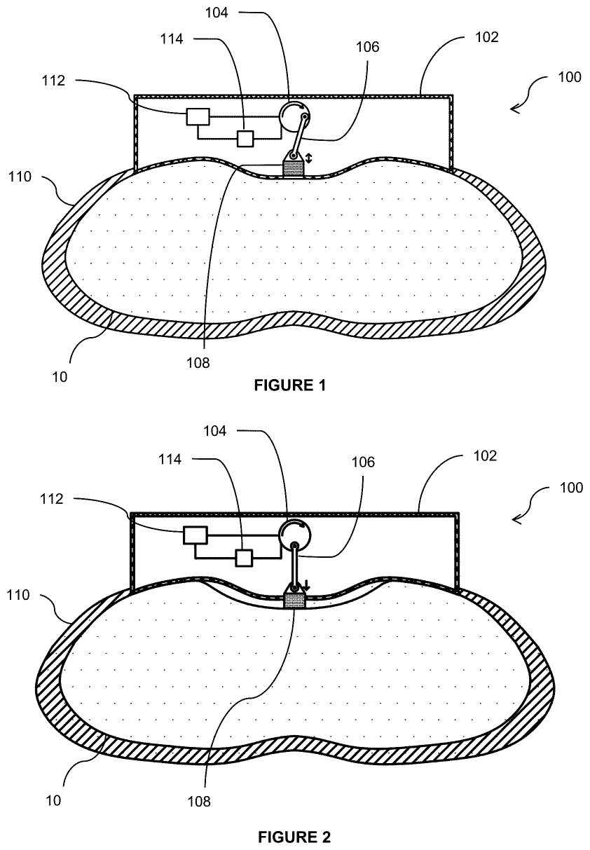

The present invention discloses a portable apparatus to deliver percussion and vibrations to a pulmonary region of a patient. Referring to the accompanying drawings, FIG. 1 discloses a cross-sectional schematic diagram of a percussion device (100) worn around the chest of the patient, in accordance with a first embodiment of the present invention. The portable apparatus comprises of a support means (110) and at least one percussion device (100).

According to one aspect of the present invention, the support means (110) is configurable as a garment means extending at least partially around the chest (10) of the patient. The garment means is selected from a group consisting of a jacket, a vest, a brace, a chest band, pair of straps, or any form of garment, which enables the percussion device (100) to be held securely in contact with the chest or back of the patient during therapy.

The support means (110) includes at least one portion to receive and hold the percussion device (100) in contact with the chest region (10). In accordance with an embodiment of the present invention, the support means (110) includes two annular members with a hollow portion formed laterally on either side. A percussion device (100) is inserted into each of the hollow portions such that two percussion devices (100) are capable of being in contact with the chest region (10) of the patient and deliver percussions to the upper, lower and side lobe of the lungs. Alternatively, the support means (110) can be of any shape and/or configuration to receive and hold the percussion device (100) in contact with the chest region (10) of the patient.

According to another aspect of the invention, the percussion device (100) simulates the tapping percussive movement, pressure force and frequency of human palms and provides the tapping percussive movement, pressure force and frequency via a contact head (108). The percussion device (100) includes a casing (102) which houses at least one actuator mechanism operatively coupled to power the at least one contact head (108) for delivering percussion and vibrations to the patient's chest or thoracic cavity (10).

The contact head (108) is positioned at 5 mm to 12 mm vertically from the rear end of the casing (102) which is contact with the chest region (10) of the patient. A hollow portion at the rear end of the casing (102) allows the contact head (108) to move in and out of the casing (102) during the therapy. An air gap is maintained between a rear end of the contact head (108) and an external surface of the rear end of the casing (102) when the contact head (108) is in the casing (102).

The actuator mechanism includes at least one DC motor (104) and a crankshaft (106) operatively connected to the DC motor (104) at one end and to the contact head (108) at the other end. Alternatively, additional mechanical components e.g. drivetrain, can be connected between the DC motor (104) and the contact head (108) for converting a rotational motion of the DC motor (104) into a linear motion of the contact head (108). Furthermore, the casing (102) can be formed with one or more sliding tracks to guide the linear motion of the contact head (108) during a chest compression cycle. The speed of the DC motor (104) is within the range of 60 to 1000 rotations per minute (rpm). The at least one contact head (108) is operatively coupled to the crankshaft (106) which drives the movement of the contact head (108) up and down perpendicular to a contact portion of the chest region (10) to deliver pulsating force to the contact portion capable of clearing lungs which are congested by obstructive mucous.

The contact head (108) is operable to compress the chest to a depth in the range of 1 to 10 mm to promote propagation of the vibrations. Further, the contact head (108) is operable to compress the chest at a frequency within the range of 1.0 to 16.67 hertz (Hz) and with a force within the range of 0.05 to 3 kilogram-force (kgf) or 0.4903325-29.41995 newton (N). According to the yet another aspect of the present invention, the contact head (108) is fabricated from a silicone material. Alternatively, the contact head (108) can be fabricated from any flexible and vibration dampening material such as a polymer or other material capable of full or partial absorption of vibrations emitted by the percussion device (100). The diameter of the contact head (108) is in the range of 10 to 50 mm. Preferably, the diameter of the contact head (108) is 38 mm for adult patients and 25 mm for children.

In accordance with this invention, the contact head (108) is driven by the actuating mechanism and the actuating mechanism is powered by any suitable electrical source (114) including but not limited to a battery, AC-DC power, or a combination of the foregoing. Preferably, the motor (104) is powered using one or more rechargeable batteries (114).

In addition, the percussion device (100) includes a controller (112) which is connected to the electrical source (114) and the actuating mechanism to turn on-off the device (100). The controller (112) can also be used for calibrating the percussion device (100) to operate it at different frequencies to provide low, medium or high frequency percussions. Further, the controller (112) can also control the speed of the motor (104). The percussion device (100) by virtue of the controller (112) can be operated in two modes namely an adult mode to generate a force in the range of 1 to 3 kgf or 9.80665-29.41995 N during therapy and a children mode to generate a pulsating force in the range of 0.05 to 0.1 kgf or 0.04903325-0.980665 N during therapy.

The percussion device (100) can also include one or more sensors (not shown in the figures), which can be in direct or indirect contact with the chest region or any other bodily part of the patient to record one or more physiological parameters of the patient. The controller (112) can be embedded with software code which enables it to use the sensed parameters to adjust frequency, speed, and/or force of the percussion device (100).

In accordance with a further aspect of the present invention, the controller (112) is communicably coupled to a communication module (not shown in the figures) which facilitates the percussion device (100) to connect or pair with external computing devices or smart devices via a customized software application. The computing devices or smart devices displays data analytics for a care giver, a medical practitioner or a therapist to view and record progress of the patient and/or receives one or more commands to control the actuating mechanism. The data analytics include strokes frequency i.e. number of strokes per second, compression depth as well as force applied while the device is in use along with sensed parameters, if any. The communication module includes wireless technologies including but not limited to WIFI, Bluetooth, ZigBee, 5G or other known wireless technologies for communicating with external computing or smart devices. Alternatively, the percussion device (100) can connect to the external computing devices or smart devices via a wired interface.

FIG. 2 is cross sectional view of the percussion device (100) while compressing the chest of the patient. According to the invention, therapy is administrated to a patient by placing the support means (110) around the chest (10) of the patient and inserting two percussion devices laterally spaced apart from each other. Each percussion device (100) is then switched on and a speed is selected. The contact head (108) of each percussion device (100) is driven by the corresponding DC motor (104) to compress the chest area predominantly the upper, lower and side lobe of the lungs in the range 1 mm to 10 mm. As seen in FIG. 2, the contact head (108) compresses the chest (10) or thoracic cavity of the patient to deliver the percussion and vibrations. Depending on the speed selection a corresponding frequency of 1.0 to 16.7 Hz is applied to each contact head (108) in the respective percussion device (100). The duration of therapy is recommended in a range of 5 minutes to 20 minutes for adults and 1 minute to 5 minutes for children. Frequency of usage of the percussion device (100) is typically once to twice a day for adults and once a day for children.

The percussion and vibrations generated by the percussion device (100) aid in loosening the obstructive mucous secretion and thick phlegm around the respiratory system to aid the patient to expel obstructive mucous secretions from the air passages in the lung. At the same time, the vibration-dampening material of the contact head (108) and the air gap facilitate in alleviating the discomfort experienced by the patients during therapy.

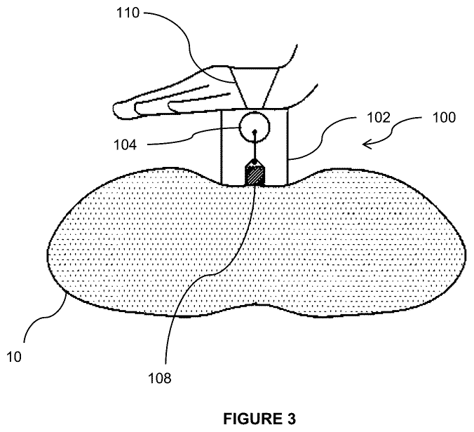

FIG. 3 shows a cross sectional view of the portable apparatus worn over a hand of a medical professional, in accordance to a second embodiment of the present invention. The apparatus comprises a support means (110) holding a percussion device (100) described in the above paragraphs. The support means (110) is configured as a band wearable over a hand of a medical professional such as physician, nurse, medical assistant and the like. The support means (110) is worn over the hand so as to hold the percussion device (100) against the chest (10) or back of the patient to deliver the percussions and/or vibrations. In another embodiment, the support means (110) is configured as one or more handles grasped by a medical professional or the patient to hold the percussion device (100) against the chest (10) or back of the patient to deliver the percussions and/or vibrations.

The percussion device (100) introduces percussion and vibrations to the patient to compress the chest (10) to a depth in the range of 1 to 10 mm at a frequency within the range of 1.0 to 16.67 Hz and with a force within the range of 0.005 to 3 kgf or 0.4903325-29.41995 N, thereby avoiding causing any pain or discomfort to the patients during therapy while maintaining the efficacy of the therapy or treatment. Even though the above embodiments show the contact head (108) delivering the percussions and vibrations at the chest region, it is to be understood that the present invention can be configured in such a way that the percussions and vibrations are deliver to a lateral side or a back of a thoracic cavity of the patient.

As used herein, the singular forms “a”, “an” and “the” may be intended to include the plural forms as well, unless the context clearly indicates otherwise. The use of the expression “at least” or “at least one” suggests the use of one or more elements, as the use may be in one of the embodiments to achieve one or more of the desired objects or results.

The invention being thus described, it will be readily appreciated by those skilled in the art that modifications may be made to the invention without departing from the embodiments as disclosed therein. Such modifications are to be considered as included in the following claim unless the claim by its language expressly states otherwise.

1. A portable apparatus to deliver percussion and vibrations to a pulmonary region of a patient, comprising:
at least one percussion device (100); and
a support means (110) for supporting the percussion device (100),
wherein the support means (110) includes at least one portion to receive and hold the percussion device (100), and
wherein the percussion device (100) includes a casing (102) having at least one actuator (104, 106) operatively coupled to power at least one contact head (108) for delivering percussion and vibrations to the patient, characterized in that:
the contact head (108) is operable to compress patient's chest region (10) or back to a depth in the range of 1 to 10 millimeters, mm, at a frequency within the range of 1.0 to 16.67 hertz, Hz, and with a force within the range of 0.05 to 3 kilogram-force, kgf or 0.4903325-29.41995 newton, N.

2. The portable apparatus as claimed in claim 1, wherein the contact head (108) is positioned between the rear end of the contact head (108) and the rear end of the casing (102) in contact with the chest region (10) or back of the patient.

3. The portable apparatus as claimed in claim 1, wherein the contact head (108) is made from a vibration-dampening material.

4. The portable apparatus as claimed in claim 1, wherein the contact head (108) is made from silicone material.

5. The portable apparatus as claimed in claim 1, wherein the contact head (108) is operable to compress the chest region (10) or back with a force within the range of 0.05-0.1 kgf or 0.4903325-0.980665 N.

6. The portable apparatus as claimed in claim 1, wherein the contact head (108) is operable to compress the chest region (10) or back with a force within the range of 1-3 kgf or 9.80665-29.41995 N.

7. The portable apparatus as claimed in claim 1, wherein the apparatus is wearable.

8. The portable apparatus as claimed in claim 7, wherein the support means (110) is configured as a garment means.

9. The portable apparatus as claimed in claim 8, wherein the garment means is selected from a group consisting of vest, jacket, brace, wrist band, palm band and chest band.

10. The portable apparatus as claimed in claim 1, wherein the apparatus is handheld and the support means (110) is configured as one or more handles.
